(19) United States
(12) Patent Application Publication
(10) Pub. No.: US 2004/0042424 A1
(43) Pub. Date: Mar. 4, 2004

(54) Switch method and device thru MAC protocol for wireless network

(76) Inventor: Hsu Hsien-Tsung, Taipei (TW)

Correspondence Address: BIRCH STEWART KOLASCH & BIRCH, PO BOX 747, FALLS CHURCH, VA, 22040-0747, US

(21) Appl. No.: 10/355,029

(22) Filed: Jan. 31, 2003

(30) Foreign Application Priority Data
Aug. 30, 2002 (TW) 091119989

(51) Int. Cl. H04Q 7/00

(52) U.S. Cl. 370/328

(57) ABSTRACT

A switch device by using a Wireless Local Network Media Access Control(MAC) protocol, including: a wired network interface, a wireless network interface, a memory element and a operation device, it exchange signals with wired network by using wired network interface, in the mean time, it exchange signals with outside another wireless network work stations utilize wireless network interface and communicating by wireless communication method, by this way, it let said switch device became an Access Point(AP) between wired network work stations and wireless network work stations; the specialty is to set a Channel Using Table and a Multi-Channel Transmission Mode Table in said memory element, by this way, we can record all transmission situations among all wireless network work stations, all using channels and channel release time, further more, providing control packets to related work stations (including the information of using channels and time), then it will switch from a common channel to an assigned data channel and operating data parallel transmission in setting time period. Based on said switch device and said switch method, we can double the wireless bandwidth among all wireless network work stations, saving data transmission time and producing more parallel throughput.

The present invention is related to a switch method and device thru Media Access Control (MAC) Protocol for wireless network, and in particular to a switch device under the structure of infrastructure wireless local network, and let all mobile work stations inside of network can get the regulation and control thru said device, and transmitting data in different channels, and increasing the utilization of network bandwidth.

### BACKGROUND OF THE INVENTION

The IEEE project 802 has formed a study group 802.11 to set up international wireless LAN standard. In an aspect of the operation mode of wireless local network are general separating two parts of Infrastructure Wireless Local Area Network (IWLAN) and Ad-Hoc Wireless Local Area Network (Ad-Hoc WLAN). The providing method and device of the present invention is just fit for said Infrastructure Wireless Local Area Network.

In the Infrastructure Wireless Local Area Network (IWLAN) as we know at present, the data transmission between mobile wireless work stations with internet, or with another wireless work stations in network is utilizing a access point AP which is by single channel mode operation mode to provide the function of transformation; In other word, all mobile wireless work stations are proceeding the job of hand-shaking, data exchanging and transformation by the firm common channel which is assigned by said access point (AP).

As shown in FIG. 1, the known method for data transmission of said Infrastructure Wireless Local Area Network (IWLAN) comprising the following steps:

STEP 1: At first, the Sender Work Station (STA-A) sends a control frame of Request-To-Send (RTS) to the Access Point (AP) to compete the channel using right;

STEP 2: As the access point (AP) receives the control frame of RTS correctly, than the access point responses a control frame of Clear To Send (CTS) to the Sender Work Station (STA-A) immediately, furthermore, asking the Sender Work Station (STA-A) send back a data frame to the access point (AP).

STEP 3: As the access point (AP) receives said data frame correctly, the access point (AP) responses a Acknowledgement (ACK) to the Sender Work Station (STA-A), to inform the correction of data transmission and to end the procedure of transmission; and

STEP 4: As the destination is a wired network (10), thus, the access point AP transforms the data to a wired network interface; On the contrary, the access point AP transforms the data from the Sender Work Station(STA-A) to inside of wireless work station(STA-B).

The Data-Link layer of local area network (LAN) is composed of Media Access Control (MAC) and Logical-Link Control (LLC) two parts. Wherein the Media Access Control (MAC) is the central part of the communication protocol of local area network, and it is charged by network interface card, and the logical-link control (LLC) is charged by LAN Driver.

According to IEEE 802.11, the transmission mode of Open System Interconnection (OSI) wherein the Physical Layer are general separating two parts of IEEE 802.11b and 802.11a; and the data rate of IEEE 802.11b is including 1, 2, 5.5 and 11 Mbps; and the bandwidth range of utilizing is from 2.4 GHz to 2.4835 GHz; furthermore, its bandwidth are separating 14 parts overlap communication channels, and causing it might be interfering among these channels, so, it could at most have three exclusive channels to be used simultaneously to avoid the problem of interference.

On the contrary, the data rate of IEEE 802.11a also include: the range of 6. 12. 18. 24. 36. 48 and 54 Mbps, and the using bandwidth include from 5.15 GHz to 5.35 GHz and 5.725 GHz to 5.825 GHz, wherein the using channels are more than 12 channels that we can use. But, under the specifications of prior art IEEE 802.11 wireless local area network, the infrastructure wireless local area network and Ad Hoc wireless local area network are all only can choose one firm unchanged channel for the purpose of data transmission, and others are idle, so, it causing the waste of wireless network channels, and this is a long-term exist defect.

This kind of bandwidth waste is always happened in the wireless network of middle or the small enterprises, but like this kind network applications are occupied very high proportions in the market of wireless local area network. Therefore, the object of the present invention is under the structure of unchanged prior art IEEE 802.11 wireless LAN specification, and at first, providing the method of communication protocol which we can double bandwidth of wireless channel among all wireless network work stations, saving data transmission time and producing more parallel transmission throughput.

### SUMMARY OF THE INVENTION

The present invention is related to a switch method and device thru media access control (MAC) protocol for wireless network, including a wired network interface, a wireless network interface, a memory element and a operation unit, it is utilizing the wired network interface to exchange signal with a wired network, and in the mean time, utilizing the wireless network interface to exchange signal with outside another wireless network work stations by way of wireless communication, by this way, let the switch device becomes a access point (AP) between a wired network and a wireless network work station; the specialty is said memory element sets a Using Channel Situation Table and a Multi-channel Transmission Mode Situation Table, by this way to record transmission situation among all wireless network work stations and all using channel and channel released time, also providing related control packets of work stations to make a common channel switch to a assigned data channel to proceed data parallel transmission in setting time, by this device and channel switch method, we can carry out two kinds of wireless switch of communication protocol operations:

First Kind: it is a two sides hand-shaking protocol which is fit for between wireless network work stations and is proceeding under the circumstances of non-barrier and non-interference; and

Second Kind: it is a three sides hand-shaking protocol which is fit for over distance among those wireless network work stations (STAs) or is proceeding under the circumstances of barrier and interference.

For moving forward to illustrate the carry out methods, including the related objects, significances and benefits of the present invention, please refer to add on drawings and description as below.

### BRIEF DESCRIPTION OF THE DRAWINGS

FIG. 1 is a schematic diagram related prior art;

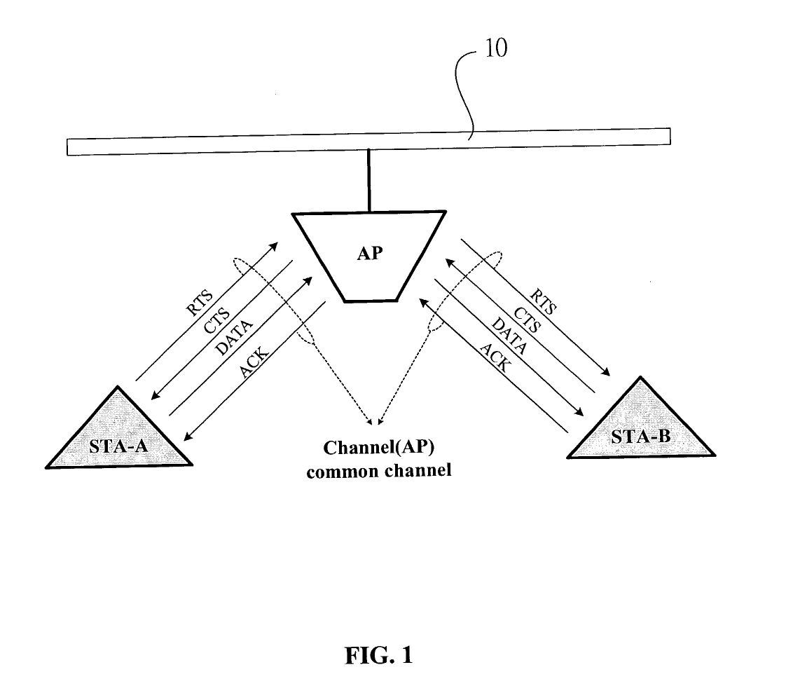

FIG. 2 is a switch device structure schematic diagram according to the present invention;

FIG. 3 is a two sides hand-shaking multi-channel transmission mode schematic diagram according to the present invention;

FIG. 4 is a three sides hand-shaking multi-channel transmission mode schematic diagram according to the present invention;

FIG. 5 is a two sides hand-shaking control frame transmission timing schematic diagram under non-barrier environment according to the present invention;

FIG. 6 is a three sides hand-shaking control frame transmission timing schematic diagram under barrier environment according to the present invention.

### DESCRIPTION OF THE PREFERRED EMBODIMENT

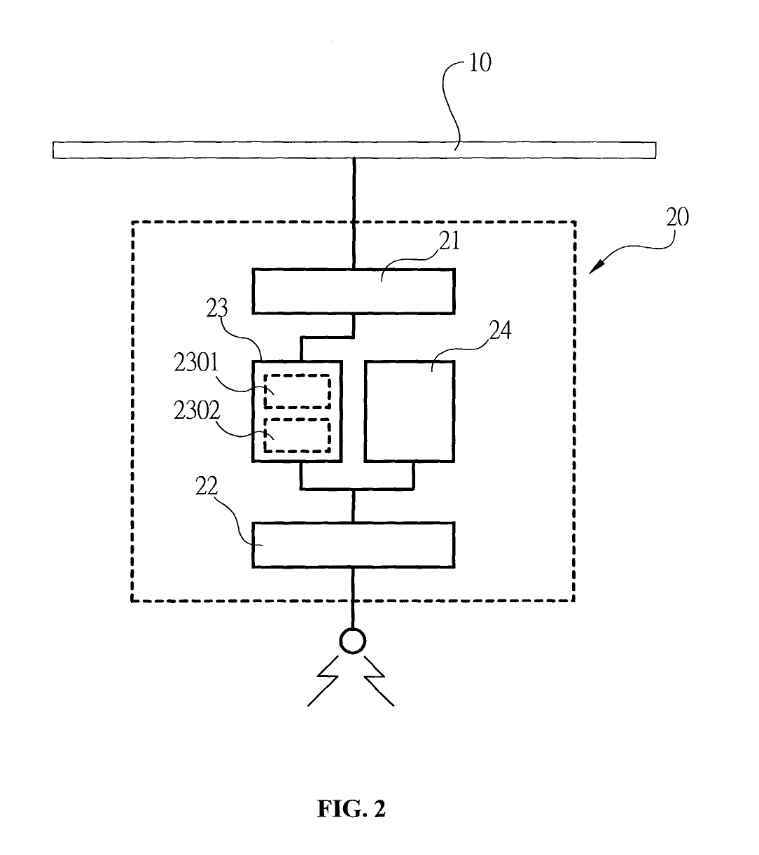

Please refer to FIG. 2, the switch device 20 of media access control protocol of the present invention may be constructed by a computer or a single chip, as long as wherein is including a wired network interface device 21, a wireless network interface device 22, a memory device and a operation device. For the purpose is proceeding signal exchange with wired network 10 by said wired network interface device 21, and in the mean time, using said wireless network interface device 22 exchanges signal with out side another wireless network work station by way of wireless communication, by this way, let the switch device 20 becomes a Access Point (AP) between a wired network and wireless network work stations.

The specialty of the present invention is setting a Using Channel Situation Table 2301 and a Multi-channel Transmission Mode Situation Table 2302 in said memory device 23, by this way to record the transmission situation of all wireless network work stations and all using channel and channel release time, further more, providing the control packets to related work stations, then let proceeding data parallel transmission from a common channel switch to a assigned data channel in setting time.

First Embodiment:

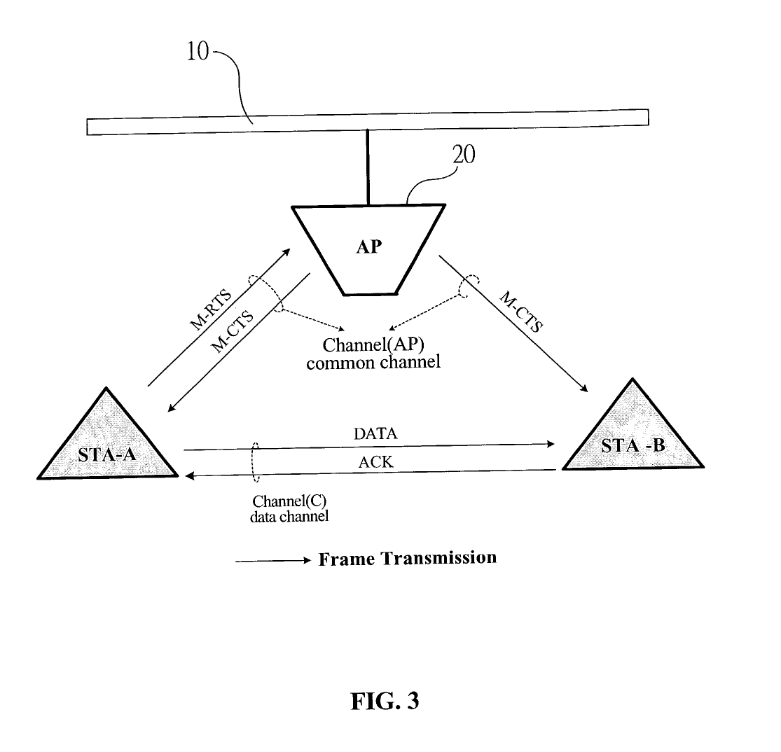

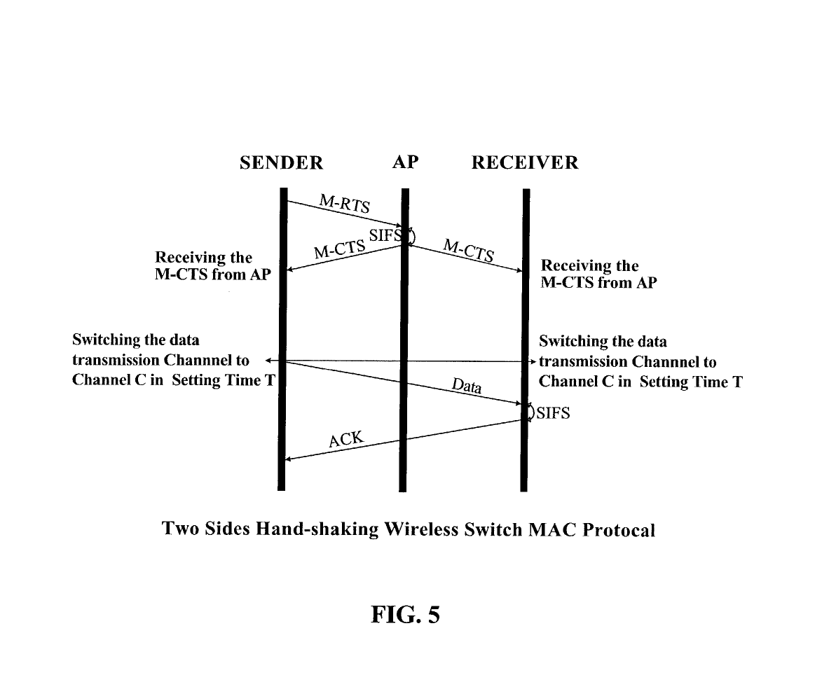

As describe above, the device and method according to the present invention may be implemented under the conditions of non-barrier and non-interference among all wireless network work stations, and to proceed communication which is base on a two sides hand-shaking wireless switch MAC protocol of IEEE 802.11 Infrastructure Wireless Area Network (IWLAN). Please refer to FIG. 3 and FIG. 5, wherein the transmission steps of control frame are comprising:

Step a: utilizing a switch device 20 to construct a Intelligent Access Point (AP) among all wireless work stations;

Step b: setting an Using Channel Situation Table 2301 in a memory device 23 of said switch device 20 to record the idle time of all channels;

Step c: transmitting a Multi-channel Request-To-Send (M-RTS) control frame from the Sender Work Station (STA-A) to said switch device 20;

Step d: inquiring the idle time of all channels in the Using Channel Situation Table 2301 by an operation device 24 of the switch device 20, and find out the earliest idle channel, after the switch device 20 has listened said M-RTS;

Step e: transmitting a Multi-channel Clear-To-Send (M-CTS) control frame from a wireless network interface device 22 of the switch device 20 to all work stations, and said M-CTS control frame, including an idle channel which is assigned by AP and a record of starting time; and

Step f: switching the data transmission channel to an assigned data channel to proceed a data parallel transmission in a setting time, as the Sender Work Station (STA-A) and the receiver work station (STA-B) received said M-CTS.

Preferably, in accordance with the present invention, let said switch device 20 became an Intelligent Access Point AP, and set a firm common channel for all wireless work stations to proceed competing and then to get the right of transmission; If the destination of data transmission is a work station in wireless network, then, the data transmission will use another data channel to release the resource of common channel. In the mean time, said common channel can provide another wireless work stations for the purpose of transmitting data to wired network 10.

Further, preferably in accordance with the present invention, the Using Channel Situation Table 2301 is built-in said Intelligent Access Point(AP), and used to record the situations of channel using and channel release time among all work stations. Therefore the best channel and the suitable channel using time could be count out through inquiring table for every time we proceeding the choice of channel and time point.

Furthermore, preferably in accordance with the present invention, through the switch device 20 of wireless switching media access control (MAC), we can transmit and receive the data directly among wireless work stations, by this way we can avoid extra channel competition and collision, and saving the network channel resource.

Second Embodiment:

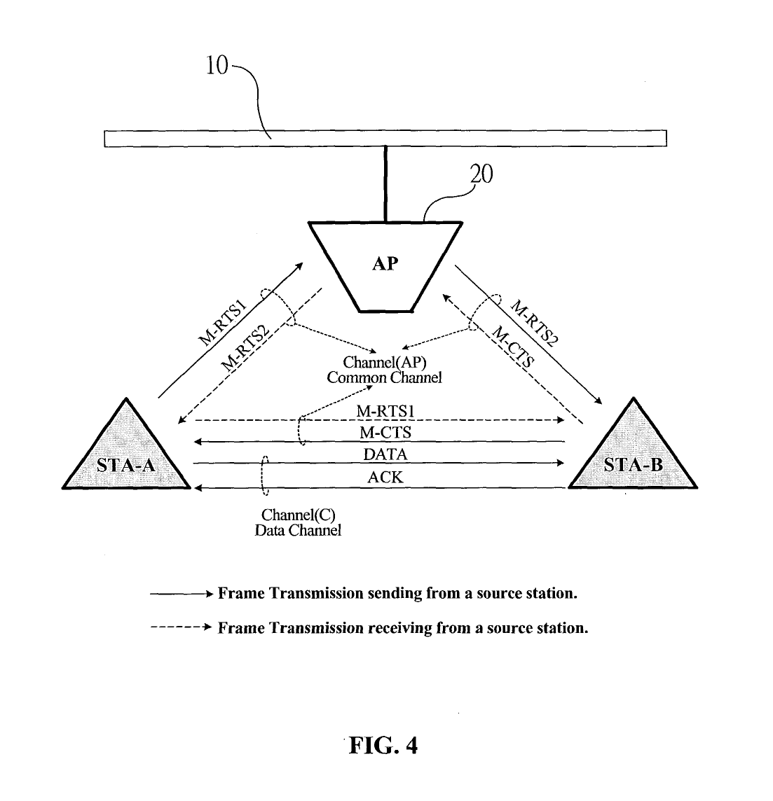

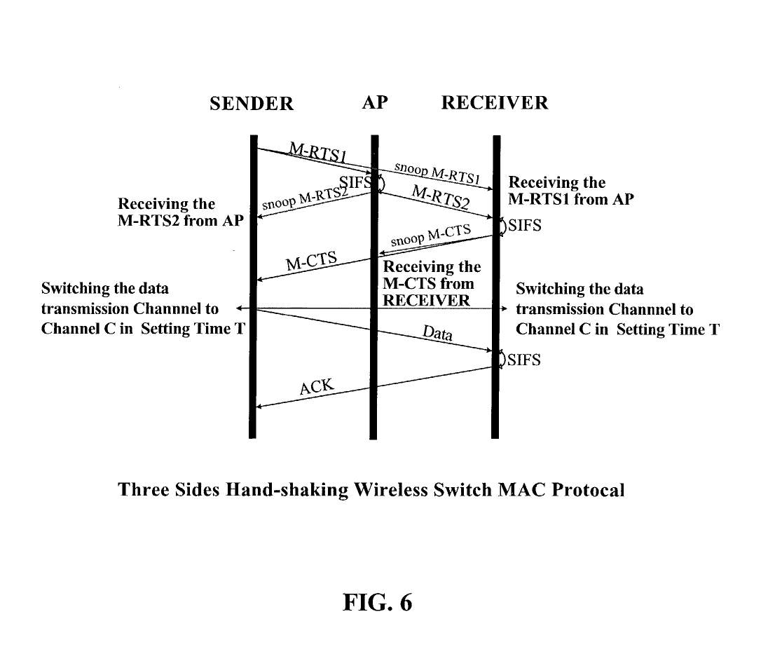

Under the circumstances of having barrier and interference, the present invention implements a three sides hand-shaking wireless switch MAC protocol. Please refer to FIG. 4 and FIG. 6, wherein the transmission steps of control frame may comprising:

Step a: constructing an Intelligent Access Point (AP) among all wireless work stations by using the switch device 20 of the present invention;

Step b: using the memory device 23 in said switch device 20 to construct a Multi-channel Transmission Mode Situation Table 2302 and a Using Channel Situation Table 2301 between any two wireless work station for recording the idle time of all channels;

Step c: transmitting a type 1 control frame of Multi-channel Request-To-Send (M-RTS1) from said Sender Work Station (STA-A) to switch device 20 first; if the transmission quality has been recorded in the switch device's situation table between Sender Work Station (STA-A) and receiver work station (STA-B) is allowing to transmit directly, then transmitting a type 2 control frame of Multi-channel Request-To-Send (M-RTS2) from said access point AP to Sender Work Station (STA-A) and receiver work station (STA-B); On the contrary, if the Multi-channel Transmission Situation Table 2302 of said switch device 20 records that it can not transmit by multi-channel, then sending back the standard CTS control frame to Sender Work Station (STA-A) immediately as soon as it receives the M-RTS1 control frame, then sending the data to said switch device 20 directly, and go back the original transmission mode of IEEE;

Step d: when said receiver work station (STA-B) receives the type 2 Multi-channel Request-To-Send (M-RTS2) control frame from said switch device 20, then transmits a Multi-channel Clear-To-Send (M-CTS) control frame to said Sender Work Station (STA-A) to confirm, in the mean time, the switch device 20 also has listened said M-CTS control frame, and according to this to correct the Using Channel Situation Table 2301; but if said receiver work station (STA-B) only receives the type 2 Multi-channel Request-To-Send (M-RTS2) control frame from said switch device 20, and loss the M RTS1 which is from said Sender Work Station (STA-A), and then send back the CTS to switch device 20 to inform the situation of hidden-node, and to record that situations to Multi-channel Transmission Mode Situation Table 2302; After, the access point AP which is constructed by switch device 20 send back CTS control frame to said Sender Work Station (STA-A) and request send the transmission data to access point AP directly, just as the original mode of IEEE;

Step e: when said Sender Work Station (STA-A) receives the M-CTS, it means that hand-shaking is working with said receiver work station (STA-B), and it will switch to another assigned data channel to transmit data in setting time.

Preferably, in accordance with the present invention, setting a all work station common channel in access point AP which is constructing by switch device 20, and it is for the purpose of competing transmission right among wireless work stations in wireless network, then switch to another assigned data channel proceeding wireless data transmission in setting time, or it can take a firm single channel to be a control center of data transmission when it can not transmit between sender and receiver directly.

Further, preferably in accordance with the present invention, wherein if there are some barriers among all work stations, the M-RTS1 is transmits from said Sender Work Station (STA-A) to switch device 20, and comparing to the transmission mode table in memory device 23 by said operation device 24, by this way, to decide whether it can be operated by multi-channel mode or not; if it can operate by multi-channel mode, then, in the same time, it send out the M-RTS2 to all work stations by wireless network interface; otherwise, it send out the control frame of CTS which is setting originally by IEEE to said Sender Work Station (STA-A), and let it recover to traditional data transmission mode.

Furthermore, preferably in accordance with the present invention, wherein if there is a barrier exists between those two work stations, then let the receiver work station (STA-B) send out a standard control frame of CTS to switch device 20, furthermore, sending back to the Sender Work Station (STA-A), at this moment, the Sender Work Station (STA-A) must back to the operation of single channel mode, and the data will transform to the receiver work station (STA-B) through the access point AP of switch device 20.

Of course, if there are some conditions of un-transmitting directly has happened between those two work stations, we can also update the built-in transmission mode table of said Intelligent Access Point AP periodically, furthermore, retry the operation of multi-channel mode to upgrade the efficiency of network. Therefore, the method and device of the present invention is suitable for two sides hand-shaking wireless switch MAC communication mode of infrastructure wireless network of IEEE 802.11 (under the environments of non-barrier and non-interference), or the present invention is suitable for three sides hand-shaking wireless switch MAC communication mode of infrastructure wireless network of IEEE 802.11 (under the environments of barrier and interference).

Please refer to FIG. 4 and FIG. 5 at the same time, through these two drawings we can understand the method of wireless network inside multi-channel. transmission MAC protocol under the conditions of non-barrier, non-interference (using the method of two sides hand-shaking) and under the conditions of barrier interference (using the method of three sides hand-shaking) among Sender Work Station receiver work station and the Intelligent Access Point AP.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A switch method for using a wireless local network media access control protocol, comprising the steps of:
setting an Intelligent Access Point (AP) among a plurality of work stations;
building an Using Channel Situation Table in said Intelligent Access Point (AP);
building a Situation Table in said Intelligent Access Point (AP) which it can recognize a Multi-Channel Transmission Mode among said work stations;
choosing a two sides hand-shaking wireless switch protocol, transmitting a control frames of Multi-channel Request-To-Send (M-RTS) from a Sender Work Station to the Intelligent Access Point (AP), and then find a best channel and an using time in said Using Channel Situation Table of Intelligent Access Point (AP), and broadcasting a control frames of Multi-channel Clear-To-Send (M-CTS) to all of the work stations; or
choosing a three sides hand-shaking wireless switch protocol, transmitting a control frames of M-RTS1 (multi-channel RTS type 1) from the Sender Work Station to said Intelligent Access Point (AP), and deciding whether to transmit by using a multi-channel mode in the Multi-channel Transmission Mode Situation Table of said Intelligent Access Point AP among all work stations or not;
if possible, then finding the best channel and the using time from said Using Channel Situation Table and transmitting a control frames of M-RTS2 (multi-channel RTS type 2) to all work stations, when a Receiver Work Station receives said M-RTS2 from said Intelligent Access Point (AP), then responding a control frame of Multi-channel Clear-To-Send (M-CTS) back to the Sender Work Station to confirm;
switching to an assigned channel for transmitting data during a setting time when the hank-shaking succeed between the Sender Work Station and the Receiver Work Station.

2. The switch method of claim 1, wherein the Intelligent Access Point (AP) is connecting to a wired network, and being a multi-channel wireless transmission center among all of the wireless work stations inside the wireless network.

3. The switch method of claim 1, wherein the Multi-channel Transmission Mode Situation Table among all of the wireless work stations is built-in said Intelligent Access Point (AP), and used to record any of using channel situation between two work stations (STAs) for determining whether it can proceed the transmitting of multi-channel mode or not.

4. The switch method of claim 1 wherein the Using Channel Situation Table is built-in said Intelligent Access Point (AP), and used to record the using situation of all channels and channel release time.

5. The switch method of claim 1, wherein the control frames of multi-channel request to send (M-RTS) is transmitting from said Sender Work Station to said Intelligent Access Point (AP), and determine the using channel and time through said access point (AP), then transmitting said control frames of Multi-channel Clear-To-Send (M-CTS) to inform the sender and receiver work station.

6. The switch method of claim 1, wherein said control frames of multi-channel RTS type 1 (M-RTS1) is transmitting from the Sender Work Station to the Intelligent Access Point (AP), and inquiring the built-in Multi-channel Transmission Mode Situation Table among the work stations, through said Intelligent Access Point (AP) to determine whether it is operating by said multi-channel mode or not, and deciding the using channel and time, and then sending the control frames of multi-channel mode type 2 (M-RTS2) to the work stations if said Intelligent Access Point (AP) recognize that it can proceed by multi-channel mode; in the mean time, it sending back the control frames of Multi-channel Clear-To-Send (M-CTS) when said receiver work station receives M-RTS2, by this way, to inform the Sender Work Station proceeding channel switching and data transmission.

7. The switch method of claim 1, wherein said control frames of Multi-channel Clear-To-Send (M-CTS) are used to conform any of said two work stations whether it can be operating by multi-channel mode or not, if the result is positive, then it means among those related work stations can switch from the common channel to another assigned channel to proceed parallel data transmission during a setting time.

8. A switch device for using a wireless local network media access control protocol, comprising:
a wired network interface device, providing said switch device to proceed exchanging signals or control frames with said wired network;
a wireless network interface device, providing said switch device to proceed exchanging signals or control frames with a plurality of work station of wireless network by wireless communication;
a memory device, comprising a built-in Using Channel Situation Table and a Multi-channel Transmission Mode Situation Table; and
a operation device, it is used to comparing with the Multi-channel Transmission Mode Situation Table to conform those between any two work stations can it be operating in multi-channel mode or not, and send out a contrary signals or control frames to outside through said wireless network interface device.

9. The switch device of claim 8 wherein said switch device is constructing by built-in the Using Channel Situation Table and the Multi-channel Transmission Mode Situation Table in a computer.

10. The switch device of claim 8 wherein said switch device is constructing by built-in said Using Channel Situation Table and said Multi-channel Transmission Mode Situation Table in a Single Chip.
